(19) United States
(12) Patent Application Publication
(10) Pub. No.: US 2018/0055271 A1
(43) Pub. Date: Mar. 1, 2018

(54) SOUS-VIDE COOKING CHAMBER

(71) Applicant: ANOVA APPLIED ELECTRONICS, INC., San Francisco, CA (US)

(72) Inventor: Jeff WU, Stafford, TX (US)

(21) Appl. No.: 15/799,848

(22) Filed: Oct. 31, 2017

Related U.S. Application Data
(63) Continuation of application No. 14/213,792, filed on Mar. 14, 2014, now abandoned.
(60) Provisional application No. 61/794,170, filed on Mar. 15, 2013.

(51) Int. Cl. A47J 27/10

(52) U.S. Cl. CPC A47J 27/10

(57) ABSTRACT

A sous-vide cooker for sous-vide cooking applications is disclosed. The sous-vide cooker is particularly suited for use in home kitchens and on small countertops. The sous-vide cooker includes a removable inner tank cooking chamber. The sous-vide cooker has a magnetic stirrer that agitates the water for better temperature homogeneity. In at least one embodiment, the sous-vide cooker can also accept multiple tank cooking chambers that each heat at different temperatures. In at least one embodiment, a temperature controller is present on the outer surface of the outer enclosure. The temperature controller may be used to control the temperature, the period of time cooking is to occur, and the degree of agitation exerted by the agitation device. In at least one embodiment, the temperature controller can be further configurable to store a number of pre-defined user settings or user-input specifications.

### CROSS-REFERENCE TO RELATED APPLICATION

This application is a continuation of U.S. application Ser. No. 14/213,792, filed Mar. 14, 2014, which claims priority to U.S. Provisional Application No. 61/794,170, filed Mar. 15, 2013, the contents of which are entirely incorporated by reference herein.

### FIELD OF TECHNOLOGY

The present disclosure relates generally to food cooking devices, and more specifically, to precision temperature control water heating appliances for evenly cooking food.

### BACKGROUND

Sous-vide is a method of cooking food sealed in airtight plastic bags in a water bath for longer than normal cooking times at an accurately regulated temperature much lower than normally used for cooking, typically around 55° C. (131° F.) to 90° C. (194° F.) for meats and vegetables. Current sous-vide cookers do not agitate the cooking water and are thus subject to temperature non-homogeneity either by food just placed into the cooker or by external disturbances; both of which can cause non-uniform cooking. Other cookers tend to agitate the cooking water using an air circulation device. Current tank based sous-vide cookers are hard to clean insofar as the entire cleaner must be emptied into a sink, which can be difficult because current tanks often hold a large volume of water.

### BRIEF DESCRIPTION OF THE DRAWINGS

In order to describe a manner in which features of the disclosure can be obtained, reference is made to specific embodiments that are illustrated in the appended drawings. Based on an understanding that these drawings depict only example embodiments of the disclosure and are not intended to be limiting of scope, the principles herein are described and explained with additional specificity and detail through the use of the accompanying drawings in which:

FIG. 1 is a cross-sectional side view of a fluidic temperature control device in accordance with an example embodiment;

FIG. 2 is a cross-sectional side view of a magnetic stirring module of a fluidic temperature control device in accordance with an example embodiment;

FIG. 3 is a top plan view of a magnetic stirring module of a fluidic temperature control device in accordance with an example embodiment;

FIG. 4 is a cross-sectional side view of a motorized stirring module of a fluidic temperature control device in accordance with an example embodiment;

FIG. 5 is a top plan view of a motorized stirring module of a fluidic temperature control device in accordance with an example embodiment; and

FIG. 6 is a perspective view of an alternative embodiment of a fluidic temperature control device.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the scope of the disclosure.

Several definitions that apply throughout this document will now be presented. “Stirring” means agitating, blending or mixing of one or more fluids. Hence a “stirrer” is a device which can be configured to agitate, blend or mix a fluid. Fluids will be understood to comprise liquids. “Sonication” means agitating one more fluids by applying sound (usually ultrasound) energy. “Coupled” is defined as connected, whether directly or indirectly through intervening components and is not necessarily limited to magnetic connections.

Broadly speaking, this disclosure relates to a sous vide cooker. Various embodiments are suited for easy cleaning, as will be explained below.

In at least one embodiment of the present disclosure, a sous-vide cooker has an outer enclosure, a removable inner tank for holding water that fits into the outer enclosure, and a removable perforated/wire holder that fits inside the removable inner tank. The outer enclosure can further include a temperature controller with display, an agitation device, and a heating element. Other components may be included within this disclosure.

In at least embodiment of the present disclosure, a removable inner tank is made of a metal that can be heated by an induction element. In an alternative embodiment of the present disclosure, the removable inner tank can be made of porcelain or porcelain coated metal, or other suitable materials. The removable inner tank may also be made to have a removable lid. The lid may be made of the same materials as the inner tank (i.e. metal or porcelain) or it may be made of clear material such as glass.

In at least one embodiment, two or more removable inner tanks may be made to fit within the outer enclosure concomitantly, to create two or more cooking zones.

In at least one embodiment, the agitation device is a magnetic stirrer coupled with a magnetic stir bar that resides in the inner tank cooking chamber and below the perforated/wire holder.

In at least one embodiment of the present disclosure, where two or more removable inner tanks may be made to fit within the outer enclosure concomitantly, and a number of agitation devices corresponding to the number of inner tanks can be provided. In this case, each inner tank can cooperatively interact with its own agitation device.

In an alternative embodiment of the present disclosure, the perforated/wire holder can be a basket structure which holds the food to be cooked above the agitation device. The basket structure or other suitable structure can prevent the food from interfering with elements of the magnetic stir bar beneath the food.

In at least one embodiment of the present disclosure, a temperature controller is present on the outer surface of the outer enclosure. The temperature controller may be used to control the temperature, the period of time cooking is to occur, and the degree of agitation exerted by the agitation device. The temperature controller may be either of analog or digital displays or both.

In at least one embodiment of the present invention, the temperature controller has a display consisting of a plurality of light-emitting diodes. In an alternative embodiment of the present invention, the temperature controller has a liquid crystal display.

In at least one embodiment of the present disclosure, the temperature controller can be further configurable to store a number of pre-defined user settings or user-input specifications.

At least one embodiment within the present disclosure is a fluidic temperature control device for sous-vide cooking. A fluidic temperature control device can include at least one outer enclosure including a temperature controller having a display element, at least one agitation device, and at least one heating element. A fluidic temperature control device can also include at least one removable inner tank configured to hold water configured to removably fit within at least a substantial portion of the outer enclosure. A fluidic temperature control device can also include a perforated wire food-receiving structure removably fitting with the removable inner tank.

In at least one embodiment of a fluidic temperature control device within the present disclosure, a heating element can comprise radiation heaters augmented with reflective elements. In at least one embodiment within the present disclosure, a plurality of removable inner tanks can fit into the outer enclosure of the fluidic temperature control device to create a plurality of cooking zones.

In at least one embodiment of a fluidic temperature control device within the present disclosure, an agitation device can be a magnetic stirrer coupled with a magnetic stir bar that resides in the inner tank and below the perforated wire holder. The magnetic stirrer can be programmed to intermittently reduce its rotational speed sufficiently to enable the stirrer to recouple with the stir bar in the event that the stir bar and the stir are not coupled. In at least one embodiment of a fluidic temperature control device within the present disclosure, the agitation device can include a plurality of magnetic stirrers with a magnetically coupled stir bar residing in each of a plurality of removable inner tanks.

In at least one embodiment of a fluidic temperature control device within the present disclosure, a removable inner tank can be composed of a metal which is heatable by an induction heater.

In at least one embodiment of a fluidic temperature control device within the present disclosure, a temperature controller can be configurable to control the temperature of the heating element at precise temperatures using fuzzy logic methods. In at least one embodiment of a fluidic temperature control device within the present disclosure, the temperature controller can be further configurable to store user-input specifications. In at least one embodiment of a fluidic temperature control device within the present disclosure, the temperature controller can be configurable to control the time of the heating element at precise temperatures. In at least one embodiment of a fluidic temperature control device within the present disclosure, the temperature controller can be configurable to control the rate of agitation. The temperature controller can also be configurable to receive one or more data inputs from an input device, the inputs comprising control commands and user-input specifications. The temperature controller can control a speaker that plays music or speech notifications.

In at least one embodiment of a fluidic temperature control device within the present disclosure, a magnetic stirrer having one or more stir bars can be used to agitate fluids. In at least one embodiment of a fluidic temperature control device within the present disclosure the removable perforated wire holder discussed above can be in the form of a basket structure.

In at least one embodiment of a fluidic temperature control device within the present disclosure, the display element discussed above can be one of a plurality of light-emitting diodes or a liquid crystal display.

In at least one embodiment of a fluidic temperature control device within the present disclosure, the heating element can be comprised of inductive, conductive, or radiation heaters.

In at least one embodiment of a fluidic temperature control device within the present disclosure, the removable inner tank can be made of stainless steel, porcelain, porcelain coated metal or polymer coated metal.

In at least one embodiment of a fluidic temperature control device within the present disclosure, the removable inner tank can also have a lid. In at least one embodiment of a fluidic temperature control device within the present disclosure, the outer enclosure can include a heat insulating layer. In at least one embodiment of a fluidic temperature control device within the present disclosure, the removable inner tank can be treated or coated to a dark color to better absorb heat from radiation heaters housed within or coupled to the fluidic temperature control device.

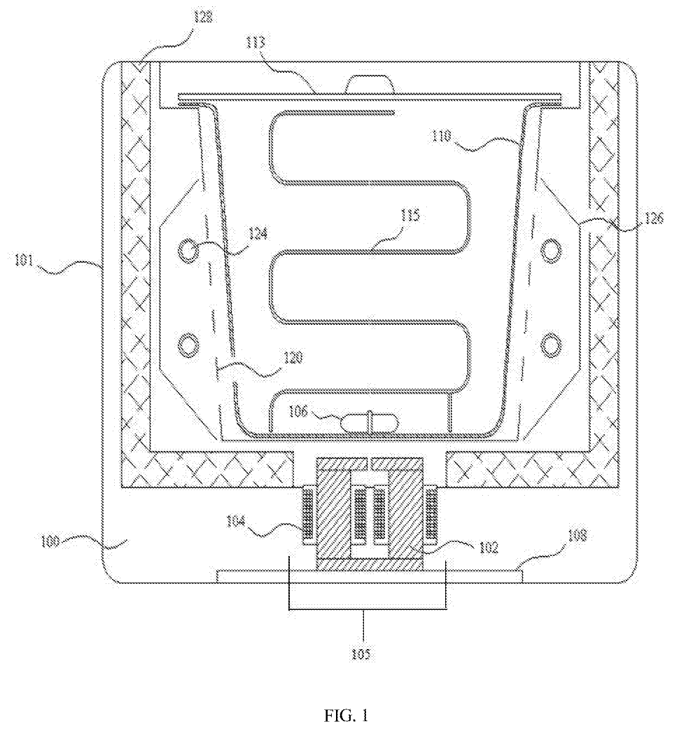

FIG. 1 illustrates a cross-sectional side view of a fluidic temperature control device 100 in accordance with an example embodiment. The temperature control device 100 generally comprises an outer enclosure 101, a removable inner tank 110 which fits inside outer enclosure 101, and a wire food holder 115 which fits inside inner tank 110. A top portion of inner tank 110 is covered by a lid 113. Inner tank 110 is heated by a radiation heater 124 positioned in an innermost portion of outer enclosure 101 and running radially along inner tank 110. Heat is transferred from heater 124 to inner tank 110 through a radiation mesh 120. A reflective insulation layer 126 runs radially along heater 124 to redirect heat generated from heater 124 toward inner tank 110 and away from outer enclosure 101. Outer enclosure 101 further comprises a heat insulation layer 128 running radially between reflective insulation layer 126 and an outer portion of outer enclosure 101. An electromagnetic device 105, comprising an electromagnet 102 and electromagnetic coils 104, is centrally located in a bottom portion of outer enclosure 101. A heat sink 108, made of a metal such as aluminum or copper, is located between electromagnetic device and the outer surface of the bottom portion of outer enclosure 101. Electromagnetic device 105 cooperatively engages, or couples, to a magnetic stir bar 106 which is located within inner tank 110. Wire food holder 115 separates the food from magnetic stir bar 106 and ensures consistent coupling of magnetic stir bar 106 with electromagnetic device 105.

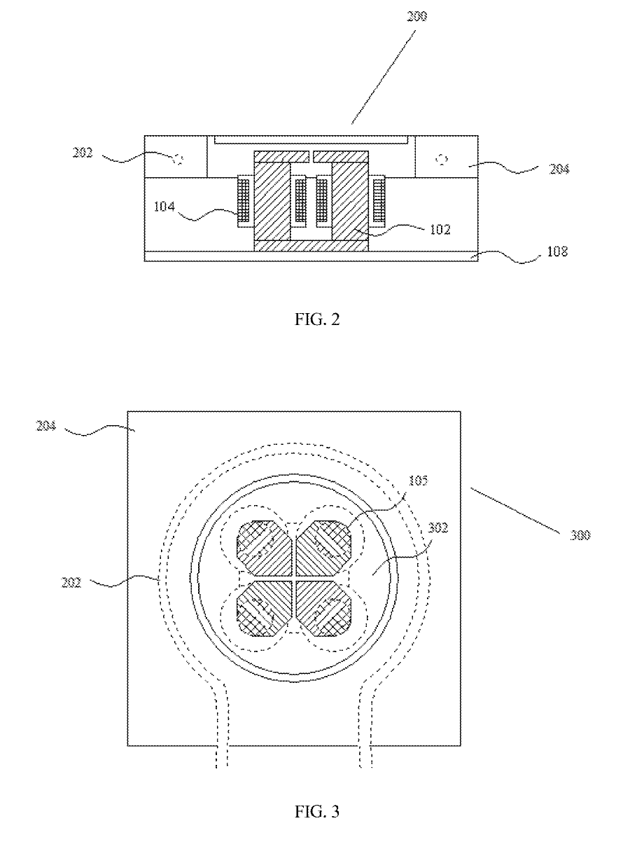

FIG. 2 illustrates a cross-sectional side view of a magnetic stirring module 200 of fluidic temperature control device 100. As in FIG. 1, magnetic stirring module 200 comprises electromagnetic device 105 and heat sink 108. Magnetic stirring module 200 further comprises a cartridge heater 202 enveloped by a heater disk 204 running radially along an upper portion of the electromagnetic device.

FIG. 3 illustrates a top plan view of a top portion 300 of magnetic stirring module 200. As illustrated in FIG. 3, an inductive magnetic stirrer housing 302 is located between electromagnetic device 105 and cartridge heater 202.

FIG. 4 illustrates a cross-sectional side view of a motorized stirring module 400 of fluidic temperature control device 100. Here, fluidic temperature control device 100 is agitated by a motorized stirrer 401 which comprises an electric motor 404, in substantially the same position as electromagnetic device 105, and a permanent magnet 402 located at a top portion of motorized stirrer 401. As in FIG. 2, motorized stirring module 400 comprises heat sink 108, cartridge heater 202 and heater disk 204.

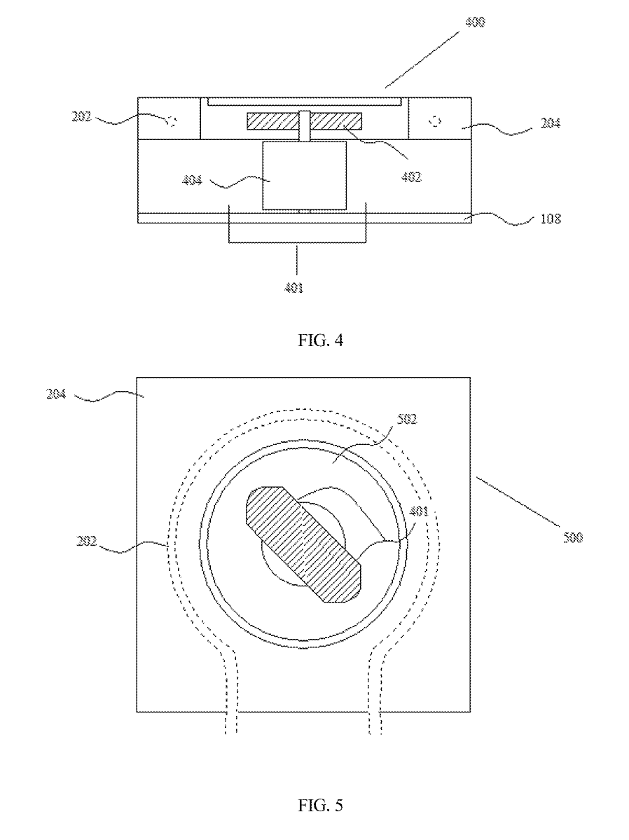

FIG. 5 is a top plan view of a top portion 500 of motorized stirring module 400. As illustrated in FIG. 5, a motorized magnetic stirrer housing 502 is located between motorized stirrer 401 and cartridge heater 202.

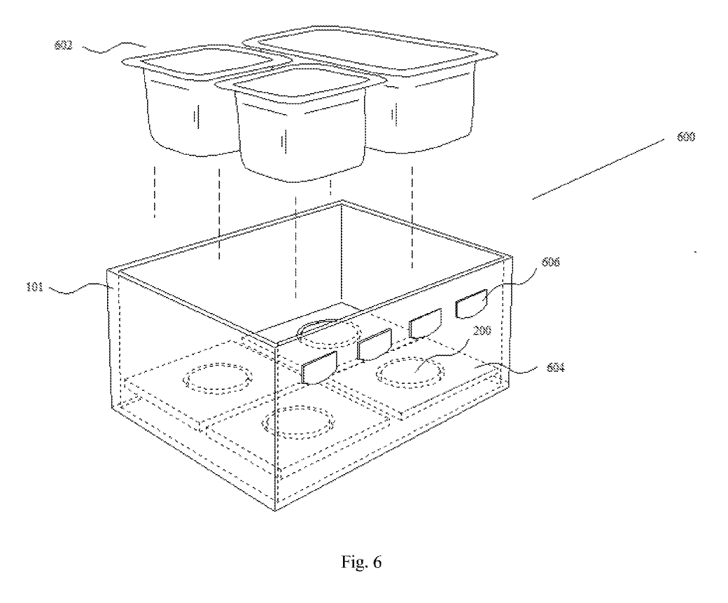

FIG. 6 is a perspective view of an alternative embodiment 600 of a fluidic temperature control device 100. As illustrated in FIG. 6, embodiment 600 comprises outer enclosure 101 and a plurality of inner tanks 602 (here three inner tanks are shown). Below inner tanks 602 are a plurality of modules 604 wherein comprising magnetic stirring modules 200. Alternatively, motorized stirring modules 400 may be used to form the plurality of modules 604. Embodiment 600 further comprises a plurality of temperature controller displays 606 which allow for selective control of each stirring module 200/300 within the plurality of modules 604.

Exemplary non-limiting embodiments have been described hereinabove. Various modifications to and departures from the disclosed embodiments will occur to those having skill in the art. The subject matter that is intended to fall within the scope of the disclosure is set forth in the following claims.

1-20. (canceled)

21. A sous-vide cooker comprising:
an outer enclosure including a temperature controller, a magnetic stirrer and a heating element, wherein the temperature controller is configured to actuate the heating element to heat a liquid and the magnetic stirrer to rotate a magnetic stir bar to agitate the liquid;
a removable inner tank configured to hold the liquid and be inserted and removed from the outer enclosure, the removable inner tank including the magnetic stir bar coupled to the magnetic stirrer and a lip configured to vertically support the inner tank by engaging the outer enclosure; and
a perforated wire holder removably fitting within the removable inner tank, wherein the perforated wire holder separates a food item from the magnetic stir bar.

22. The sous-vide cooker of claim 21, wherein the heating element comprises at least one radiation heater augmented with at least one reflective element.

23. The sous-vide cooker of claim 21, wherein the heating element is configurable at precise temperatures using fuzzy logic methods.

24. The sous-vide cooker of claim 21, wherein the heating element is configurable to operate at precise temperatures for a specific time.

25. The sous-vide cooker of claim 21, wherein the heating element is one of an inductive heater or a conductive heater.

26. The sous-vide cooker of claim 21, wherein the removable inner tank is composed of a metal heatable by an induction heater.

27. The sous-vide cooker of claim 21, wherein the removable inner tank is composed of a stainless steel, porcelain, porcelain coated metal or polymer coated metal.

28. The sous-vide cooker of claim 21, wherein the removable inner tank further comprises a lid.

29. The sous-vide cooker of claim 21, wherein the outer enclosure further comprises a heat insulating layer.

30. The sous-vide cooker of claim 21, wherein the removable inner tank is treated or coated with a dark color to absorb heat from one or more radiation heaters.

31. The sous-vide cooker of claim 21, wherein a plurality of removable inner tanks fit into the outer enclosure to create a plurality of cooking zones.

32. The sous-vide cooker of claim 31, further comprising a plurality of magnetic stirrers coupled with a plurality of magnetic stir bars residing in each of the plurality of removable inner tanks.

33. The sous-vide cooker of claim 21, wherein the magnetic stir bar resides in the inner tank and below the perforated wire holder.

34. The sous-vide cooker claim 21, wherein the magnetic stirrer is programmed to intermittently reduce its rotational speed sufficiently to enable the magnetic stirrer to recouple with the magnetic stir bar in the event that the magnetic stir bar and the magnetic stirrer are not coupled.

35. The sous-vide cooker of claim 21, wherein the magnetic stirrer is configurable to control the rate of agitation.

36. The sous-vide cooker claim 21, wherein the removable perforated wire holder is a basket structure.

37. The sous-vide cooker of claim 21, further comprising a memory for storing input specifications.

38. The sous-vide cooker of claim 21, further comprising an input device configurable to receive one or more data inputs, the inputs including control commands or input specifications.

39. The sous-vide cooker of claim 21, further comprising a speaker that plays music or speech notifications.

40. The sous-vide cooker of claim 21, further comprising a display, wherein the display is one of a plurality of light-emitting diodes or a liquid crystal display.
